(19) United States
(12) Patent Application Publication
(10) Pub. No.: US 2010/0302356 A1
(43) Pub. Date: Dec. 2, 2010

(54) METHOD AND ARRANGEMENT FOR PRESENTING INFORMATION IN A VISUAL FORM

(75) Inventor: Hasse Sinivaara, San Jose, CA (US)

Correspondence Address: YOUNG & THOMPSON, 209 Madison Street, Suite 500, Alexandria, VA, 22314, US

(73) Assignee: SAVOX COMMUNICATIONS OY AB (LTD), Espoo (FI)

(21) Appl. No.: 12/675,840

(22) PCT Filed: Aug. 31, 2007
(86) PCT No.: PCT/FI07/00216

§ 371 Date: Apr. 27, 2010

(51) Int. Cl. H04N 7/18; H04N 5/33; G09G 5/00

(52) U.S. Cl. 348/61; 348/164; 345/8; 348/E05.09; 348/E07.085

(57) ABSTRACT

The invention relates to a method and arrangement for extending viewing capability of a user who is looking through a transparent sheet. The transparent sheet can be, for example, a lens of goggles, an eye shield of a breathing mask, a visor of a helmet, or a windscreen of a vehicle. The arrangement comprises a receiver device (101) adapted to receive electromagnetic radiation, e.g. infrared radiation, that is outside the visual spectral region. The arrangement comprises a converter device (102) adapted to produce an electrical signal (111) at least partly on the basis of information carried by the received electromagnetic radiation. The arrangement comprises a transparent sheet (103) that has an electrically switchable diffractive optical area (104) adapted to display information carried by the electrical signal.

### FIELD OF THE INVENTION

The invention relates to a method and arrangement for extending viewing capability of a user who is looking through a transparent sheet. The transparent sheet can be, for example, a lens of goggles, an eye shield of a breathing mask, a visor of helmet, or a windscreen of a vehicle.

### BACKGROUND

In operational environments of persons like firefighters, soldiers, and policemen the visibility may be limited due to things like smoke, gasses, and darkness. In order to solve this problem, several systems have been offered which work with infrared cameras by which a user of e.g. a breathing mask is not reliant for only visible light for detecting his operational environment. Especially for firefighters systems of the kind described above are useful, because infrared radiation from individuals and sources of fire can be easily recorded with an infrared camera. Publications EP1107041, WO0140844, and US2003/0058544 disclose solutions in which a breathing mask is equipped with a display device. The display device has at least one projector, e.g. a liquid crystal display screen, providing an image directed onto a partially transparent reflector inserted in the line of sight of a user of the breathing mask. The partially transparent reflector allows about 80% of incoming visible light to get through it. Therefore, the user is able to see not only images superimposed with the projector but also his operational environment behind the partially transparent reflector. The images fed to the at least one projector are provided with a camera recording non-visible light, e.g. infrared light.

A projector adapted to superimpose images and an arrangement for providing a surface on which the images are superimposed require, however, physical room in conjunction with e.g. an eye shield of a breathing mask or a visor of a helmet. Therefore, a solution based on a projector introduces significant limitations to mechanical design of e.g. an eye shield of a breathing mask or a visor of a helmet. Furthermore, when designing a system based on a projector and a partially transparent reflector one has to make a compromise between the following factors: intensity of light provided with the projector and a degree of transparency of the partially transparent reflector, i.e. a share of incoming visible light that can get through the partially transparent reflector. If the degree of transparency is low, images can be superimposed on the partially transparent reflector using a relatively low light intensity but a low degree of transparency impairs user's ability to see his operational environment. On the other hand, if a higher degree of transparency is used, the light intensity has usually to be increased in order to superimpose images on the partially transparent reflector. Also a high light intensity used for superimposing images on the partially transparent reflector impairs the user's ability to see his operational environment. In many cases it may be a difficult task to find a degree of transparency for the partially transparent reflector such that an acceptable operation would be provided in environments having varying conditions with respect to darkness, smoke, gasses, fog, etc.

### SUMMARY

An object of the present invention is to provide a new method and a new arrangement for presenting information in a visual form such that the above-described drawbacks associated with the prior art are eliminated or reduced. It is also an object of the present invention to provide a new display apparatus such that the above-described drawbacks associated with the prior art are eliminated or reduced.

The objects of the present invention are achieved by using a transparent sheet that has an electrically switchable diffractive optical area for presenting, in a visual form, information carried by electromagnetic radiation that is outside a visual spectral region. The electromagnetic radiation outside the visual spectral region can be, for example, infrared radiation.

In accordance with a first aspect of the invention, there is provided a new arrangement for presenting information in a visual form. The arrangement comprises:
a receiver device adapted to receive electromagnetic radiation that is outside the visual spectral region,
a converter device adapted to produce an electrical signal at least partly on the basis of information carried by said electromagnetic radiation, and
a transparent sheet comprising an electrically switchable diffractive optical area adapted to display information carried by said electrical signal.

In accordance with a second aspect of the invention, there is provided a new display apparatus. The display apparatus comprises:
a receiver device adapted to receive electromagnetic radiation that is outside the visual spectral region,
a converter device adapted to produce an electrical signal at least partly on the basis of information carried by said electromagnetic radiation, and
a transparent sheet comprising an electrically switchable diffractive optical area adapted to display information carried by said electrical signal.

In accordance with a third aspect of the invention, there is provided a new method for presenting information in a visual form. The method comprises:
receiving electromagnetic radiation that is outside the visual spectral region,
producing an electrical signal at least partly on the basis of information carried by said electromagnetic radiation, and
using a transparent sheet that has an electrically switchable diffractive optical area for displaying information carried by said electrical signal.

A benefit provided by embodiments of the present invention when compared with the prior art solution of the kind described above is that there is more freedom in the mechanical design of e.g. an eye shield of a breathing mask or a visor of a helmet. Furthermore, in comparison with the prior art solution of the kind described above, it is easier to achieve an acceptable operation in environments having varying conditions with respect to darkness, smoke, gasses, fog, etc, because there is no need to make compromises with respect to a degree of transparency.

There are a lot of different applications in which different embodiments of the invention can be used. A display apparatus according to an embodiment of the invention can be for example:
a military helmet comprising a visor that is arranged to present, in a visual form, information carried by electromagnetic radiation outside the visual region,
a breathing mask comprising eye shields arranged to present, in a visual form, information carried by electromagnetic radiation outside the visual region,
a vehicle mounted device a part of which is a windscreen of the vehicle, the windscreen being arranged to present, in a visual form, information carried by electromagnetic radiation outside the visual region, or
a system having goggles the lenses of which are arranged to present, in a visual form, information carried by electromagnetic radiation outside the visual region.

Various embodiments of the invention both as to constructions and to methods of operation, together with additional objects and advantages thereof, will be best understood from the following description of specific embodiments when read in connection with the accompanying drawings.

The embodiments of the invention presented in this document are not to be interpreted to pose limitations to the applicability of the appended claims. The verb “to comprise” is used in this document as an open limitation that does not exclude the existence of also unrecited features. The features recited in depending claims are mutually freely combinable unless otherwise explicitly stated.

### BRIEF DESCRIPTION OF THE FIGURES

Embodiments of the invention presented in the sense of examples and their advantages are explained in greater detail below with reference to the accompanying drawings, in which

FIG. 1 shows a block diagram of an arrangement according to an embodiment of the invention for presenting information in a visual form,

FIG. 2 shows a block diagram of an arrangement according to an embodiment of the invention for presenting information in a visual form,

FIGS. 3, 4, and 5 show display apparatuses according to embodiments of the invention,

FIGS. 6 and 7 are flow charts of methods according to embodiments of the invention for presenting information in a visual form.

### DETAILED DESCRIPTION OF THE EMBODIMENTS

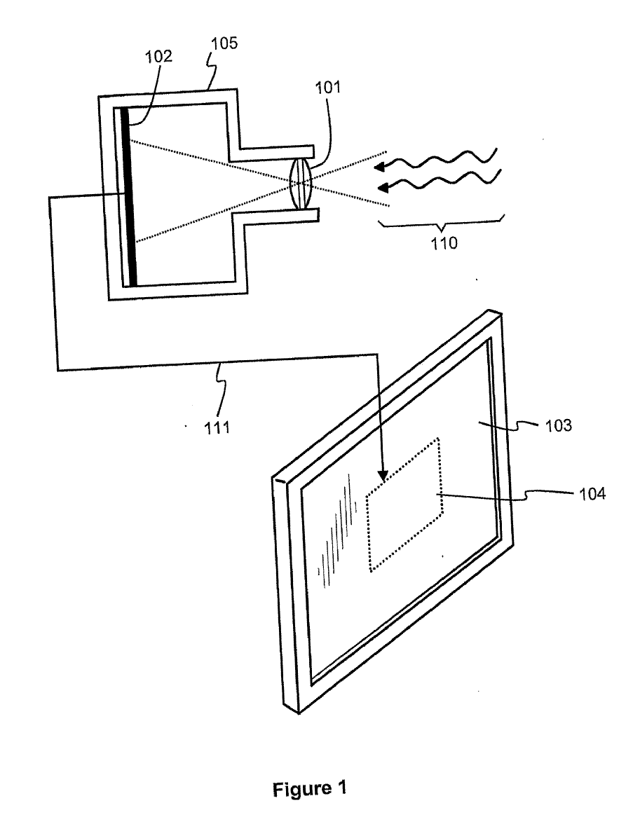

FIG. 1 shows a block diagram of an arrangement according to an embodiment of the invention for presenting information in a visual form. The arrangement comprises a receiver device 101 adapted to receive electromagnetic radiation 110 that is outside the visual spectral region. The arrangement comprises a converter device 102 adapted to produce an electrical signal 111 at least partly on the basis of information carried by the received electromagnetic radiation 110. The arrangement comprises a transparent sheet 103 that has an electrically switchable diffractive optical area 104 adapted to display information carried by the electrical signal 111. The transparent sheet 103 can be, for example, a lens of goggles, an eye shield of a breathing mask, a visor of a helmet, or a windscreen of a vehicle. The receiver device 101 is a lens system of a camera 105 that is preferably an electronic infrared camera (IR-camera). The converter device 102 comprises a cell array of the camera 105 and image processing electronics such as amplifier, memory, and image correcting components. The information displayed on the electrically switchable diffractive optical area 104 can be, for example, an image captured by the camera 150 or a processed version of the image. The electrically switchable diffractive optical area 104 can comprise, for example, a liquid crystal filled polymer structure (LiCFiPS) that is essentially a polymer structure between two substrates carrying transparent electrode coatings, the spaces between the substrates being filled with liquid crystal. As the effective refractive index of liquid crystal changes with applied electrical field, the refractive index and also the optical path length difference between the polymer and liquid crystal regions gives rise to a controlled spatial phase modulation of light. The LiCFiPS is described with more detail e.g. in publication “Electrically switchable diffractive optical element”, G. Lester, A. Studwick, and S. Coulston, Opto-Electronics Review, 12, no. 3, 2004.

The electrically switchable diffractive optical area 104 is at least partially transparent, i.e. visible light is able to penetrate the diffractive optical area 104. Therefore, image presented with the diffractive optical area 104 is an enhancement on top of a natural view. For example, if there is smoke in a physical environment of the arrangement, a user of the arrangement can see the smoke and the camera 105 and the diffractive optical area 104 provide additional visual information about, for example, individuals and sources of fire. By this way a visible environment experienced by the user is not only a virtual environment based on the received information captured with the camera 105 but the visible environment experienced by the user is a combination of a natural view and the virtual environment.

In the arrangement shown in FIG. 1, the electrically switchable diffractive optical area 104 does not cover the whole area of the transparent sheet 103 but only a main view area. It is, however, also possible to cover the whole area of the trans-parent sheet with an electrically switchable diffractive optical area. The manufacturing of the arrangement is, however, more cost effective if the electrically switchable diffractive area does not cover the whole area of the transparent sheet.

An arrangement according to an embodiment of the invention comprises a receiver device adapted to receive electromagnetic radiation that is above the visual spectral region. The arrangement comprises a converter device adapted to produce an electrical signal at least partly on the basis of information carried by the received electromagnetic radiation. The arrangement comprises a transparent sheet that has an electrically switchable diffractive optical area adapted to display information carried by the electrical signal. The receiver device can be e.g. a sensor for ultraviolet radiation or a sensor for X-rays. The arrangement can be used e.g. for giving a visual warning about dangerous radiation sources.

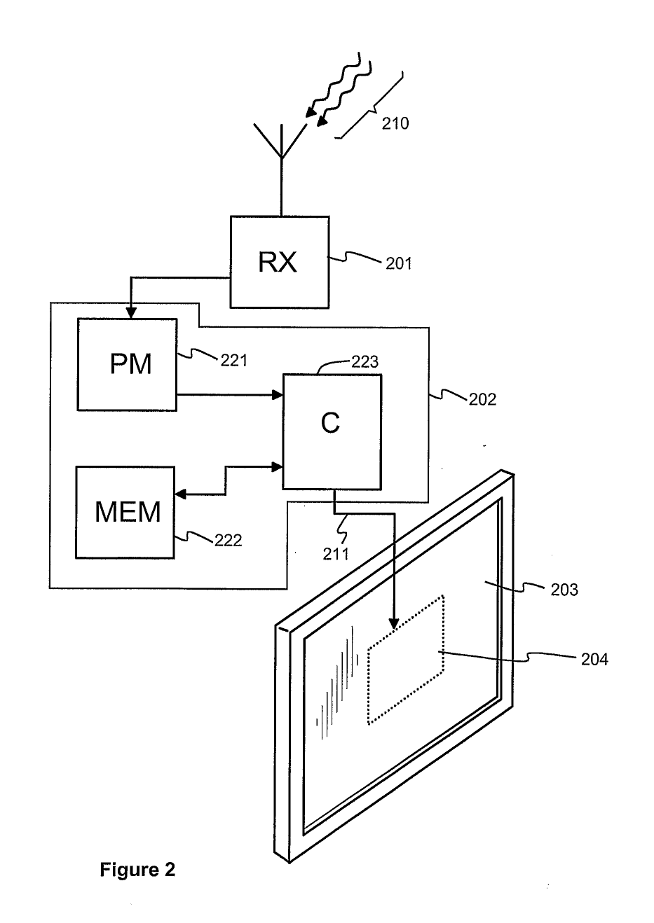

FIG. 2 shows a block diagram of an arrangement according to an embodiment of the invention for presenting information in a visual form. The arrangement comprises a receiver device 201 adapted to receive electromagnetic radiation 210 that is outside the visual spectral region. The arrangement comprises a converter device 202 adapted to produce an electrical signal 211 at least partly on the basis of information carried by the received electromagnetic radiation 210. The arrangement comprises a transparent sheet 203 that has an electrically switchable diffractive optical area 204 adapted to display information carried by the electrical signal 211. The receiver device 201 is a radio receiver that is arranged to receive a positioning signal 210 from a satellite. The converter device 202 comprises a positioning module 221 that is arranged to determine a geographical position of the arrangement on the basis of the positioning signal 210. The converter device 202 comprises a memory device 222 that is arranged to contain pre-stored data. The pre-stored data can comprise, for example, information on landscape shapes, roads, and/or buildings of physical environments of different places. The converter device 202 comprises a controller 223 that is arranged to retrieve from the memory device 222 a piece of the pre-stored data on the basis of the geographical position and to produce the electrical signal 211 on the basis of the retrieved piece of the pre-stored data. The piece of the pre-stored data can comprise information for example on landscape shapes, roads, and/or buildings of the physical environment that corresponds with the determined geographical position.

A visible environment experienced by a user of the arrangement shown in FIG. 2 is not only a virtual environment based on information retrieved from the memory device 222 according to the determined geographical position but the visible environment experienced by the user is a combination of the natural view and the virtual environment. Therefore, image presented with the diffractive optical area 204 is an enhancement on top of the natural view. The image presented with the diffractive optical area 204 can present, for example, islands and islets on a foggy sea.

In an arrangement according to an embodiment of the invention the radio receiver 201 and the positioning module 221 are arranged to use at least one of the following: a positioning signal of the GPS (Global Positioning System) owned by USA, a positioning signal of the European Galileo positioning system, and a positioning signal of the Russian GLONASS positioning system.

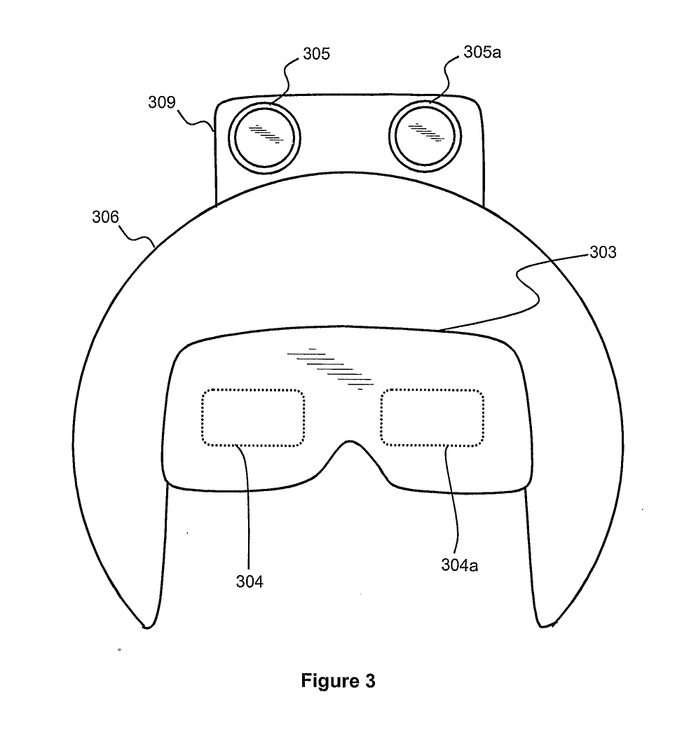

FIG. 3 shows a display apparatus according to an embodiment of the invention. The display apparatus comprises a helmet 306 and a control unit 309 that is mounted on the helmet. The control unit 309 comprises a receiver device adapted to receive electromagnetic radiation that is outside the visual spectral region and a converter device adapted to produce an electrical signal at least partly on the basis of information carried by the received electromagnetic radiation. The helmet 306 comprises a visor 303 that has electrically switchable diffractive optical areas 304 and 304a adapted to display information carried by the electrical signal. A camera 305 and associated image processing electronics constitute the above-mentioned receiver device and the converter device. The camera 305 is preferably an electronic infrared camera.

In a display apparatus according to an embodiment of the invention the control unit 309 comprises two cameras 305 and 305a, and the control unit 309 is adapted to control the electrically switchable diffractive optical area 304 according to the information captured with the camera 305 and to control the electrically switchable diffractive optical area 304a according to the information captured with the camera 305a.

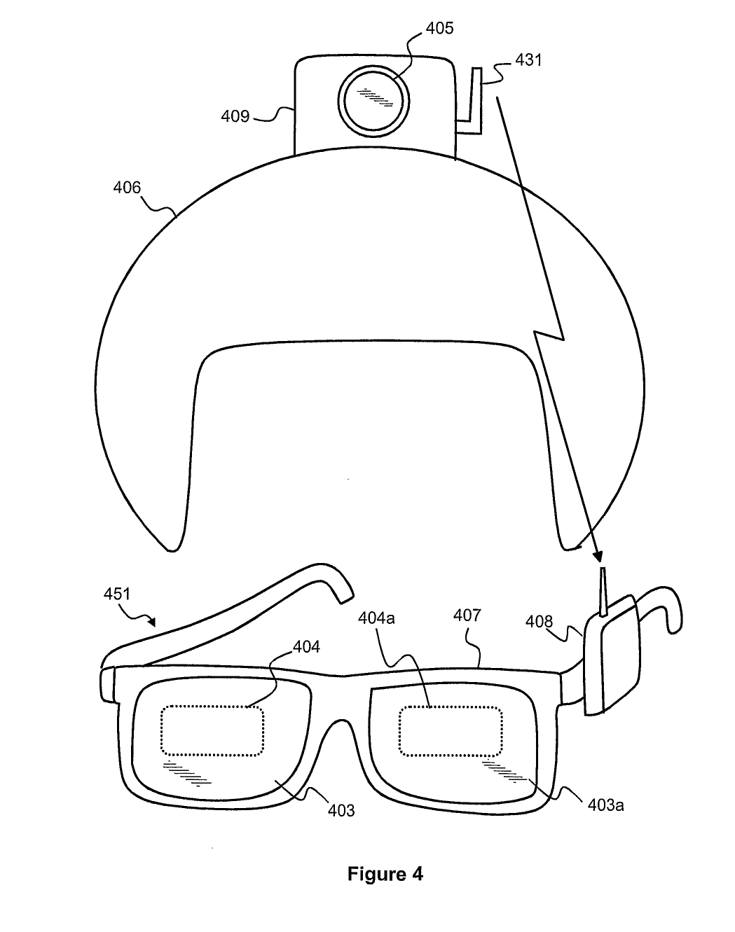

FIG. 4 shows a display apparatus according to an embodiment of the invention. The display apparatus comprise goggles 451 and a control unit 409. The goggles comprise a frame 407, a first lens 403 having an electrically switchable diffractive optical area 404, a second lens 403a having an electrically switchable diffractive optical area 404a, and a radio receiver 408. The control unit 409 comprises a receiver device adapted to receive electromagnetic radiation that is outside the visual spectral region, a converter device adapted to produce an electrical signal at least partly on the basis of information carried by the received electromagnetic radiation, and a radio transmitter 431. A camera 405 and associated image processing electronics constitute the above-mentioned receiver device and the converter device. The camera 405 is preferably an electronic infrared camera. The radio transmitter 431 and the radio receiver 408 are arranged to establish a data trans-fer link from the control unit 409 to the goggles 451. The radio transmitter 431 is arranged to convert the electrical signal produced with the converter device into a radio signal and the radio receiver 408 is arranged to regenerate the electrical signal on the basis of the radio signal. The electrically switchable diffractive optical areas 404 and 404a are adapted to display information carried by the regenerated electrical signal.

In the example shown in FIG. 4, the control unit 409 is mounted on a helmet 406. Alternatively, the control unit can be equipped, for example, with suspension straps that can be used for attaching the control unit 409 to a body of a user of the display apparatus.

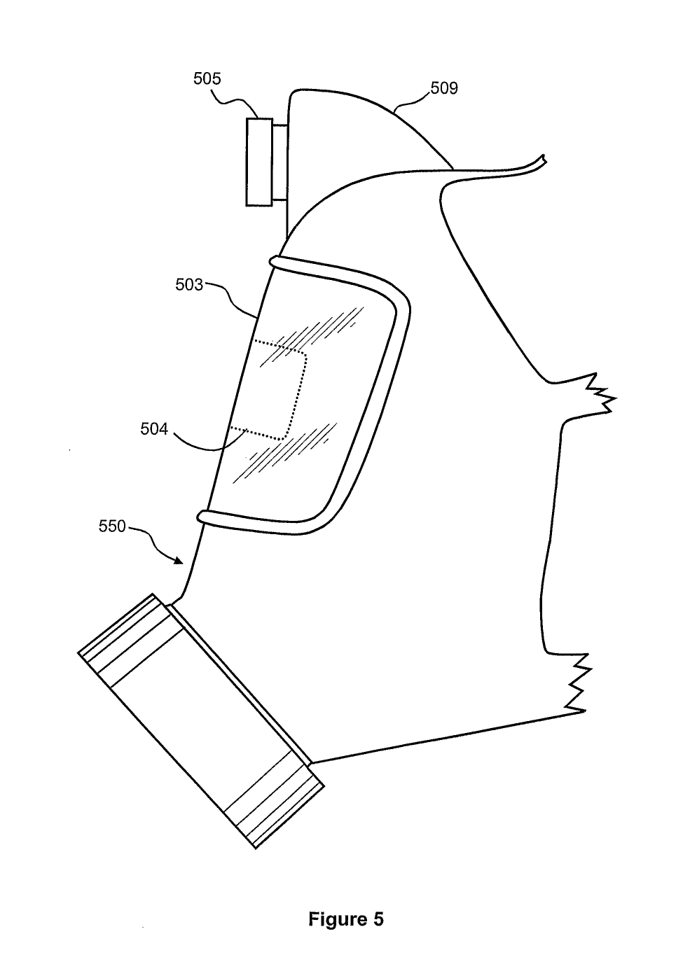

FIG. 5 shows a display apparatus according to an embodiment of the invention. The display apparatus comprise a breathing mask 550 and a control unit 509 that is mounted on the breathing mask. The control unit 509 comprises a receiver device adapted to receive electromagnetic radiation that is outside the visual spectral region and a converter device adapted to produce an electrical signal at least partly on the basis of information carried by the received electromagnetic radiation. The breathing mask 550 comprises an eye shield 503 that has an electrically switchable diffractive optical area 504 adapted to display information carried by the electrical signal. A camera 505 and associated image processing electronics constitute the above-mentioned receiver device and the converter device.

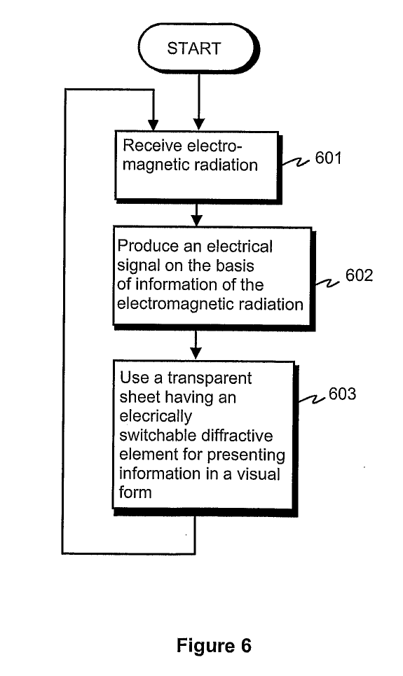

FIG. 6 is a flow chart of a method according to an embodiment of the invention for presenting information in a visual form. In phase 601, electromagnetic radiation that is outside the visual spectral region is received. In phase 602, an electrical signal is produced at least partly on the basis of information carried by the received electromagnetic radiation. In phase 603, a transparent sheet comprising an electrically switchable diffractive optical area is used for displaying information carried by the electrical signal.

In a method according to an embodiment of the invention the electromagnetic radiation is received 601 with a lens system of an electronic infrared camera and a cell array of the electronic infrared camera is used for producing 602 the electrical signal.

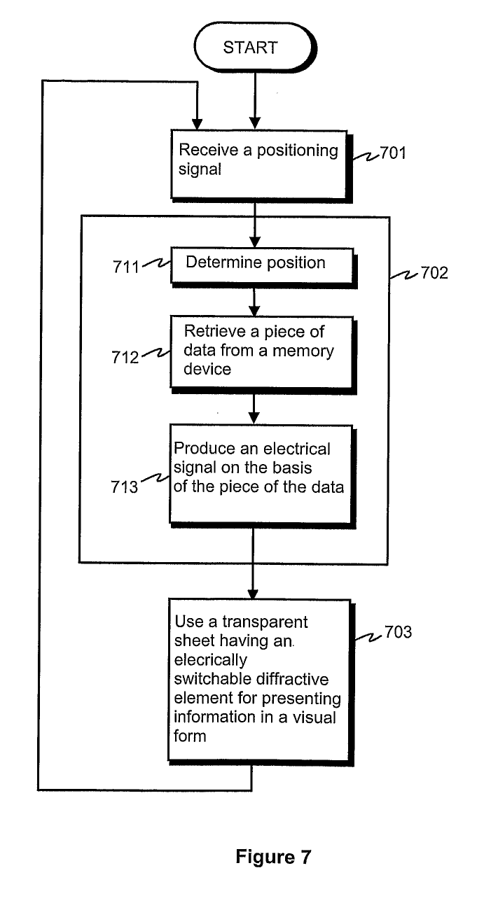

FIG. 7 is a flow chart of a method according to an embodiment of the invention for presenting information in a visual form. In phase 701, electromagnetic radiation is received with a radio receiver that is adapted to receive a positioning signal from a satellite. In phase 702, an electrical signal is produced at least partly on the basis of information carried by the received positioning signal. The phase 702 comprises sub-phases 711, 712, and 713. In the sub-phase 711, a geographical position is determined on the basis of the received positioning signal. In the sub-phase 712, a piece of pre-stored data is retrieved from a memory device on the basis of the determined geographical position. In the sub-phase 713, the above-mentioned electrical signal is produced on the basis of the retrieved piece of the pre-stored data. The piece of the pre-stored data may comprise information on features of a physical environment that corresponds with the determined geographical position, e.g. landscape shapes, roads, and/or buildings.

In a method according to an embodiment of the invention at least one of the following is used for determining the geographical position: a positioning signal of the GPS (Global Positioning System), a positioning signal of the Galileo positioning system, and a positioning signal of the GLONASS positioning system.

While there have been shown and described and pointed out fundamental novel features of the invention as applied to embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. The specific examples provided in the description given above should not be construed as limiting. Therefore, the invention is not limited merely to the embodiments described above, many variants being possible without departing from the scope of the inventive idea defined in the independent claims appended hereto.

1-15. (canceled)

16. An arrangement for presenting information in a visual form, the arrangement comprising:
a receiver device adapted to receive electromagnetic radiation that is outside a visual spectral region,
a converter device adapted to produce an electrical signal at least partly on the basis of information carried by said electromagnetic radiation, and
a transparent sheet having an electrically switchable diffractive optical area adapted to display information carried by said electrical signal and the receiver device comprises a sensor for one of the following: ultraviolet radiation and X-rays.

17. An arrangement according to claim 16, wherein said receiver device comprises a lens system of an electronic infrared camera and said converter device comprises a cell array of said electronic infrared camera.

18. An arrangement according to claim 16, wherein said receiver device comprises a radio receiver arranged to receive a positioning signal from a satellite and said converter device comprises a positioning module arranged to determine a geographical position on the basis of the positioning signal, a memory device arranged to contain pre-stored data, and a controller arranged to retrieve from the memory device a piece of the pre-stored data on the basis of the geographical position and to produce said electrical signal on the basis of said piece of the pre-stored data.

19. An arrangement according to claim 18, wherein said piece of the pre-stored data comprises information on at least one of the following features of a physical environment that corresponds with said geographical position: landscape shapes, roads, and buildings.

20. An arrangement according to claim 18, wherein said radio receiver and said positioning module are arranged to use at least one of the following: a positioning signal of the GPS (Global Positioning System), a positioning signal of the Galileo positioning system, and a positioning signal of the GLONASS positioning system.

21. A display apparatus comprising:
a receiver device adapted to receive electromagnetic radiation that is outside a visual spectral region,
a converter device adapted to produce an electrical signal at least partly on the basis of information carried by said electromagnetic radiation, and
a transparent sheet having an electrically switchable diffractive optical area adapted to display information carried by said electrical signal and the receiver device comprises a sensor for one of the following: ultraviolet radiation and X-rays.

22. A display apparatus according to claim 21, wherein the display apparatus further comprises a helmet, said transparent sheet being a visor of the helmet.

23. A display apparatus according to claim 21, wherein the display apparatus further comprises another transparent sheet having another electrically switchable diffractive optical area, a frame of goggles having a radio receiver, and a control unit including said receiver device, said converter device, and a radio transmitter arranged to establish a data transfer link from the control unit to the goggles, said transparent sheet being a first lens of the goggles and said other transparent sheet being a second lens of the goggles.

24. A display apparatus according to claim 21, wherein the display apparatus further comprises a breathing mask, said transparent sheet being an eye shield of the breathing mask.

25. A method for presenting information in a visual form, the method comprising:
receiving electromagnetic radiation that is outside a visual spectral region,
producing an electrical signal at least partly on the basis of information carried by said electromagnetic radiation,
using a transparent sheet that has an electrically switchable diffractive optical area for displaying information carried by said electrical signal and the electromagnetic radiation represents one of the following: ultraviolet radiation and X-rays.

26. A method according to claim 25, wherein said electromagnetic radiation is received with a lens system of an electronic infrared camera and a cell array of said electronic infrared camera is used for producing said electrical signal.

27. A method according to claim 25, wherein said electromagnetic radiation is received with a radio receiver that is adapted to receive a positioning signal from a satellite and said electrical signal is produced by determining a geographical position on the basis of the positioning signal, by retrieving from a memory device a piece of pre-stored data on the basis of the geographical position, and by producing said electrical signal on the basis of the piece of the pre-stored data.

28. A method according to claim 27, wherein the piece of the pre-stored data comprises information on at least one of the following features of a physical environment that corresponds with said geographical position: landscape shapes, roads, and buildings.

29. A method according to claim 27, wherein at least one of the following is used for determining the geographical position: a positioning signal of the GPS (Global Positioning System), a positioning signal of the Galileo positioning system, and a positioning signal of the GLONASS positioning system.
